(19) United States
(12) Patent Application Publication
(10) Pub. No.: US 2015/0375732 A1
(43) Pub. Date: Dec. 31, 2015

(54) METHOD AND SYSTEM FOR CONTROLLING A DRIVELINE OF A HYBRID VEHICLE

(71) Applicant: BAE SYSTEMS HÄGGLUNDS AKTIEBOLAG, Örnsköldsvik (SE)

(72) Inventors: Mats NORDLÖF, Örnsköldsvik (SE); Olof NORÉUS, Domsjö (SE)

(73) Assignee: BAE Systems Hägglunds Aktiebolag, Örnsköidsvik (SE)

(21) Appl. No.: 14/766,723

(22) PCT Filed: Jan. 24, 2014
(86) PCT No.: PCT/SE2014/050087

§ 371 Date: Aug. 7, 2015

(30) Foreign Application Priority Data
Feb. 8, 2013 (SE) 1350152-3

(51) Int. Cl. B60W 20/00; B60W 10/08; B60W 10/06

(52) U.S. Cl. CPC B60W 20/10; B60W 10/06; B60W 10/08; B60W 2710/0677; B60W 2710/083; B60W 2710/081; B60W 2710/0666; B60W 2710/0644; Y10S 903/93

(57) ABSTRACT

A driveline of a vehicle includes an internal combustion engine unit for driving a generator unit for generating electrical energy, an electric motor unit arranged to be supplied with said electrical energy from said generator unit, an AC/DC conversion unit configured to convert AC voltage from the generator unit to DC voltage, and a DC/AC conversion unit configured to convert said DC voltage to controllable AC voltage. The driveline is controlled based on desired efficiency, or based on desired power output and based on criteria related to the performance of said internal combustion engine unit, and control based on desired efficiency or desired power output is selected.

### TECHNICAL HELD

The invention relates to a method for controlling a driveline of a vehicle according to the preamble of claim 1. The invention relates to a system for controlling a drive line of a vehicle according to the preamble of claim 8. The invention also relates to a motor vehicle. The invention also relates to a computer program and a computer program product.

### BACKGROUND

It is known in propulsion of vehicles to use series hybrid driveline comprising an internal combustion engine unit arranged to drive a generator unit for generating electrical energy, together with at least one electric motor unit arranged to be supplied with said electrical energy.

One problem with such drivelines is that the power of the installed internal combustion engine rarely or never can be fully utilized.

WO0025417 discloses a system for controlling a vehicle's hybrid driveline with an internal combustion engine and an electric motor, where the driveline is arranged to be controlled for operation of the internal combustion engine along an ideal operating line for optimized efficiency.

### OBJECT OF THE INVENTION

An object of the present invention is to achieve a method for controlling a driveline of a vehicle in a way that enables utilization of the available power of the internal combustion engine in a reliable and efficient manner.

### SUMMARY OF THE INVENTION

These and other objects, which will become apparent from the following description, are achieved by a method, system, vehicle, and computer program and computer program product of the initially mentioned kind and which further exhibit the features indicated in the characterizing part of appended independent claims 1, 8, 15, 16 and 17. Preferred embodiments of the method and system are defined in appended dependent claims 2-7 and 9-14.

According to the invention, the objects are achieved by a method for controlling a driveline of a vehicle, which driveline comprises at least one internal combustion engine unit for driving a generator unit for generating electrical energy, at least one electric motor unit arranged to be supplied with said electric energy from said generator unit, said driveline comprising an AC/DC conversion unit configured to convert AC voltage from the generator unit into DC voltage, a DC/AC conversion unit configured to convert said DC voltage to controllable AC power, wherein said DC voltage is provided in an intermediate DC voltage stage, together with means for controlling the driveline of the vehicle, comprising the steps of, by means of said means: i) controlling the driveline based on desired efficiency, or ii) controlling the driveline based on desired power output and iii) based on criteria related to the performance of said internal combustion engine unit, selecting control based on desired efficiency or desired power output. This enables use of the available power of the internal combustion engine unit in a reliable and efficient manner. Since all available power is utilized the internal combustion engine unit does not have to be over-dimensioned. Fault tolerance acceptance is hereby increased since the power that is still available in performance-reducing fault conditions of the internal combustion engine unit can be fully utilized by controlling the torque of the internal combustion engine so that the control unit of the internal combustion engine can regulate to maximum torque given any prevailing restrictions. Furthermore, lowest possible energy consumption without engine shutdown is enabled by optimizing the operating point of the internal combustion engine unit.

In one embodiment of the method, said performance comprises the maximum power that can be delivered by the internal combustion engine unit. This enables use of the available power of the internal combustion engine unit in a reliable and efficient manner.

In one embodiment, the method comprises the step of controlling said driveline based on desired efficiency in case the desired power output is less than the maximum power that said internal combustion engine unit can deliver. This enables the lowest possible energy consumption without engine shutdown by optimizing the operating point of the internal combustion engine unit.

In one embodiment of the method, the step of controlling said driveline based on desired efficiency comprises selection of a suitable operating point of the internal combustion engine unit, wherein said electric drive motor unit is controlled such that a desired tractive force of said electric motor unit is achieved. Hereby efficiency is optimized.

In one embodiment the method comprises the step of controlling said driveline based on desired power output in case the desired power output exceeds or coincides with the maximum power deliverable by said internal combustion engine. This reduces the risk that the throttle unit of the internal combustion engine unit bottoms and so avoids that power reduction of the internal combustion engine unit causes the internal combustion engine unit to stop. Consequently, engine shutdown is hereby avoided.

In one embodiment of the method, the step of controlling said driveline based on desired power output includes driving the internal combustion engine unit with maximum power through maximum throttle, and controlling the motor speed by controlling the torque of the generator unit while controlling the power output of the driving motor. This reduces the risk that the throttle unit of the internal combustion engine unit bottoms and so avoids that power reduction of the internal combustion engine unit causes the internal combustion engine unit to stop. Consequently, engine shutdown is hereby avoided.

In one embodiment, the method comprises the step of switching between control based on desired efficiency and control based on desired power output, based on operating parameters of said driveline, comprising torque of the internal combustion engine unit and motor speed of the internal combustion engine unit. This enables the lowest possible energy consumption without engine shutdown through internal combustion engine unit operating point optimization.

According to the invention, the objects are achieved by a system for controlling a driveline of a vehicle, which driveline comprises at least an internal combustion engine unit for driving a generator unit for generating electrical energy, at least one electric motor unit arranged to be supplied with said electric power from said generator unit, wherein said driveline comprises an AC/DC conversion unit configured to convert the AC voltage from the generator unit into DC voltage, a DC/AC conversion unit configured to convert said DC voltage to controllable AC power, wherein said DC voltage is provided in an intermediate DC voltage stage, together with means for controlling the driveline of the vehicle, wherein said means for controlling the driveline comprises means for controlling the driveline based on desired efficiency, and means for controlling the driveline based on the desired power output, and means for selecting control based on desired efficiency or desired power output, based on criteria relating to the performance of the internal combustion engine unit. This enables use of the available power of the internal combustion engine unit in a reliable and efficient manner. Since all available power is utilized, the internal combustion engine unit does not have to be over-dimensioned. Fault tolerance acceptance is hereby increased since the power still available in performance-reducing fault conditions of the internal combustion engine unit can be fully utilized by controlling the torque of the internal combustion engine so that the control unit of the internal combustion engine can regulate to maximum torque given any prevailing restrictions. Furthermore, this enables the lowest possible energy consumption without engine shutdown by optimizing the operating point of the internal combustion engine unit.

In one embodiment of the system, said performance comprises the maximum power deliverable by the internal combustion engine. This enables use of the available power of the internal combustion engine unit in a reliable and efficient manner.

In one embodiment, the system comprises means for controlling said driveline based on desired efficiency if the desired power output is less than the maximum power deliverable by said internal combustion engine unit. This enables the lowest possible energy consumption without engine shutdown by optimizing the operating point of the internal combustion engine unit.

According to one embodiment of the system, said means for controlling said driveline based on desired efficiency comprises means for selecting a suitable operating point of the internal combustion engine unit, and means for controlling said electric drive motor unit such that a desired tractive force of said electric motor unit is achieved. Hereby efficiency is optimized.

In one embodiment, the system comprises means for controlling said driveline based on desired power output if the desired power output exceeds or coincides with the maximum power deliverable by said internal combustion engine unit. This reduces the risk that the throttle unit of the internal combustion engine unit bottoms and so avoids that power reduction of the internal combustion engine unit causes the internal combustion engine unit to stop. Consequently, engine shutdown is hereby avoided.

In one embodiment of the system, said means for controlling said driveline based on desired power output comprises means for driving the internal combustion engine unit with maximum power through maximum throttle, and means for controlling the motor speed by controlling the torque of the generator unit while controlling the power output of the drive motor. This reduces the risk that the throttle unit of the internal combustion engine unit bottoms and so avoids that power reduction of the internal combustion engine unit causes the internal combustion engine unit to stop. Consequently, engine shutdown is hereby avoided.

According to one embodiment, the system comprises means for switching between control based on desired efficiency and control based on desired power output, based on operational parameters of said driveline, comprising the torque of the internal combustion engine unit and the motor speed of the internal combustion engine unit. This enables the lowest possible energy consumption without engine shutdown by optimizing the operating point of the internal combustion engine unit.

### DESCRIPTION

This invention will be better understood by reference to the following detailed description read together with the accompanying drawings, wherein like reference characters refer to like parts throughout the different views, and in which:

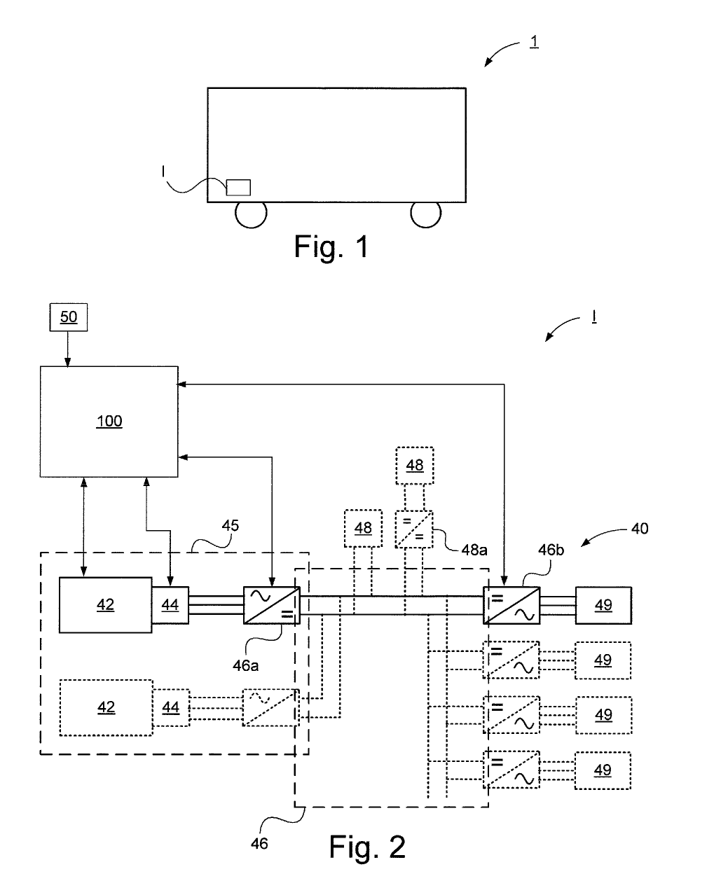

FIG. 1 schematically illustrates a motor vehicle according to an embodiment of the present invention;

FIG. 2 schematically illustrates a block diagram of a system for controlling a driveline of a vehicle according to an embodiment of the present invention.

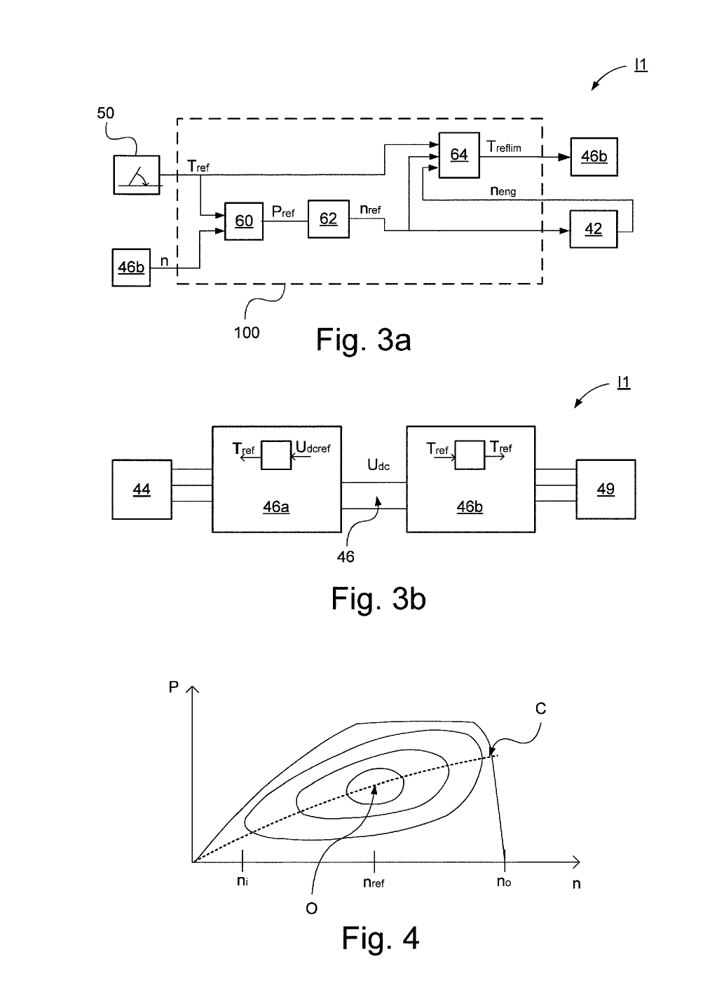

FIGS. 3a-b schematically illustrate a block diagram of a first control principle for controlling the system in FIG. 2 according to an embodiment of the present invention;

FIG. 4 schematically illustrates the power over speed characteristics of an internal combustion engine unit of a vehicle based on the control principle in FIGS. 3a-b;

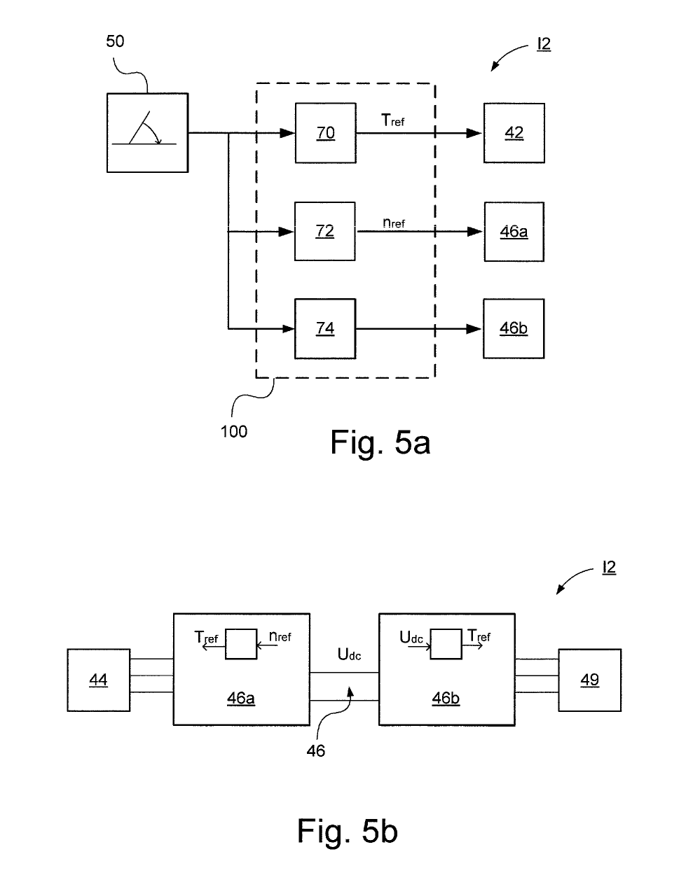

FIGS. 5a-b schematically illustrates a block diagram of a second control principle for controlling the system in FIG. 2 according to an embodiment of the present invention;

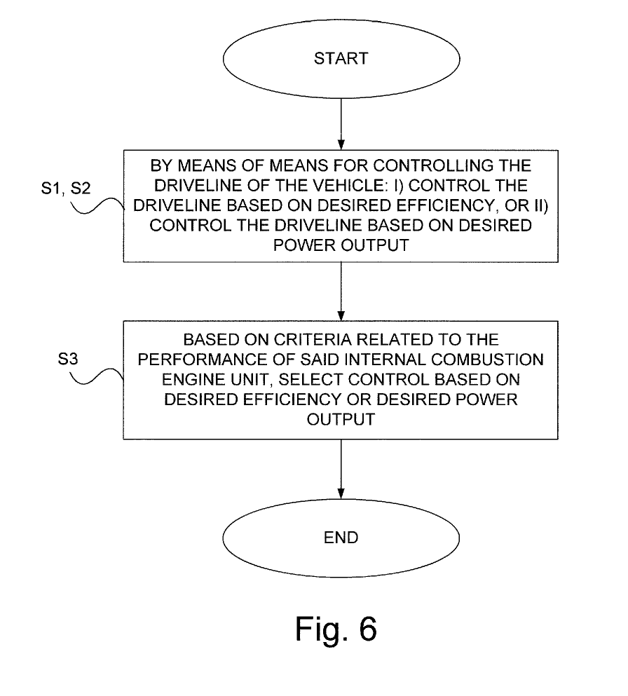

FIG. 6 schematically illustrates a block diagram of a method according to the present invention;

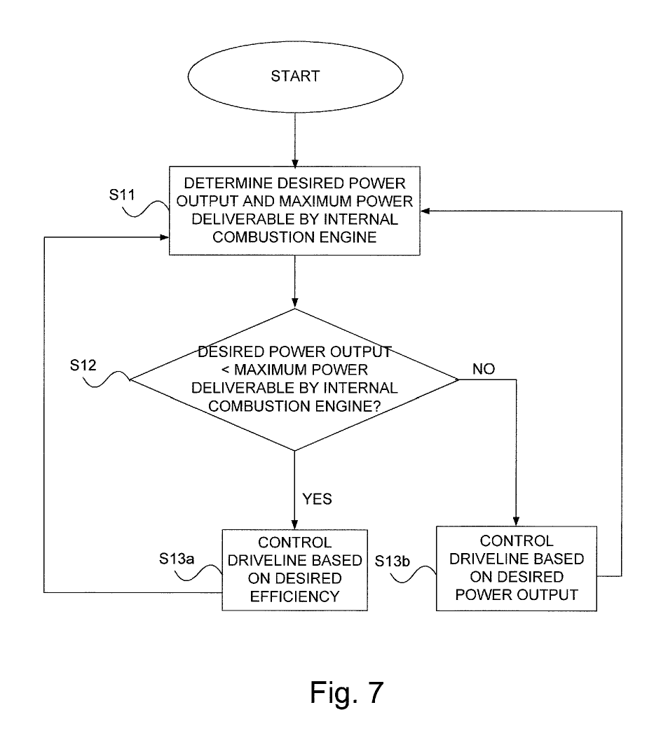

FIG. 7 schematically illustrates a block diagram of a method according to the present invention; and

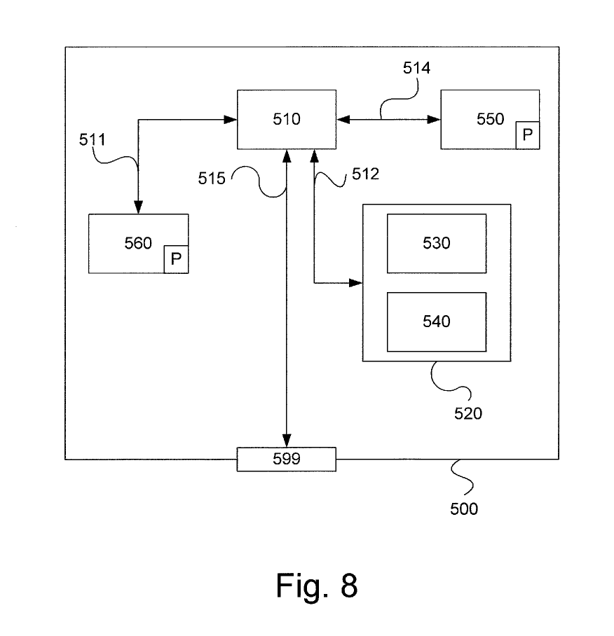

FIG. 8 schematically illustrates a computer according to an embodiment of the present invention.

### DESCRIPTION OF EMBODIMENTS

Herein the term “link” refers to a communication link which may be a physical line such as an optoelectronic communication line, or a non-physical line such as a wireless connection, for example a radio or microwave link.

FIG. 1 schematically illustrates a motor vehicle 1 according to an embodiment of the present invention. The exemplary vehicle 1 is a heavy vehicle in the form of a working vehicle. The vehicle may be any suitable vehicle such as a military vehicle, an automobile, a truck or the like. The vehicle comprises a system for controlling a driveline of a vehicle.

FIG. 2 schematically illustrates a block diagram of a system for controlling a driveline of a vehicle according to an embodiment of the present invention.

The system comprises a driveline 40 for the propulsion of a motor vehicle. The driveline 40 comprises at least one internal combustion engine unit 42, wherein the internal combustion engine unit 42 according to one exemplary embodiment is a diesel engine. In this case, the driveline 40 is a diesel-electric driveline.

The driveline 40 further comprises a generator unit 44 connected to said internal combustion engine unit 42, and in case of several internal combustion engine units each internal combustion engine unit is connected to a generator unit. The generator unit 44 may comprise one or more generators. Said internal combustion engine unit 42 is arranged to drive said generator unit 44 to generate electrical energy. In one embodiment the driveline comprises means for providing gearing between the internal combustion engine unit 42 and the generator unit and/or means for operating mechanically coupled components such as a hydraulic pump, a compressor or the like.

The driveline further comprises an AC/DC conversion unit 46a connected to the generator unit 44 and configured to convert AC voltage from the generator unit 44 to DC voltage.

Said internal combustion engine unit 42, generator unit 44 and AC/DC conversion unit form an energy generating unit 45 for generating electrical energy.

The driveline further comprises a DC/AC conversion unit 46b connected to the AC/DC conversion unit 46a and configured to convert the DC voltage to controllable AC voltage.

Thereby, an intermediate DC voltage stage 46 is formed between said AC/DC conversion unit 46a and said DC/AC conversion unit 46b. Thus, the driveline 40 comprises an intermediate DC voltage stage 46.

Said driveline comprises at least one electric motor unit 49 for the propulsion of a vehicle, arranged to be supplied with said generated electrical energy. Said electric motor unit 49 is arranged to be supplied with said electrical energy. In FIG. 2, four electric motor units 49 are shown, three of which are drawn in dashed lines to illustrate that the driveline 40 may comprise one or more electric motor units.

The motor speed and torque of said at least one electric motor unit 49 are controlled by the AC voltage converted to controllable AC voltage from DC voltage by means of the DC/AC conversion unit 46b.

In one embodiment, the driveline 40 comprises an energy storage device 48. Said energy storage device 48 comprises, in one embodiment, one or more supercapacitors. In an alternative embodiment, said energy storage device 48 comprises one or more battery units. In one embodiment, said energy storage device comprises both super capacitor and battery unit. Said intermediate DC voltage stage 46 is, in one embodiment, directly connected to said energy storage device 48. Said energy storage device 48 is arranged to store said generated electric energy from the generator unit and energy converted from kinetic energy during braking, as well as electric charge from charging stations or the like.

In one embodiment, the driveline 40 comprises a power conversion unit in form of a DC/DC conversion unit 48a arranged between the energy storage device 48 and the intermediate DC voltage stage so that the effect of the energy storage device 48 can be controlled independent of the voltage over the intermediate DC voltage stage 46.

The system I further comprises a throttle unit 50 for determination of throttle for desired torque, forming the basis of torque on the DC/AC conversion unit 46b and thereby the electric motor unit 49.

The system I further comprises means for controlling the driveline 40. Said means comprising at least one electronic control unit 100 for controlling the driveline 40.

The electronic control unit is signal-connected to said internal combustion engine unit 42 via a link. The electronic control unit is arranged to receive a signal from said internal combustion engine unit 42 representing operational data for determination of the power that can be delivered by the internal combustion engine unit.

The electronic control unit 100 is signal-connected to said internal combustion engine unit 42 via a link. The electronic control unit 100 is arranged to send a signal to said internal combustion engine unit 42 representing motor speed data for reference speed of the internal combustion engine unit 42 during control in accordance with a first control principle I1 shown in FIGS. 3a-b, and torque data for reference torque representing requested torque requested by the throttle unit 50 during control in accordance with a second control principle I2 shown in FIGS. 5a-5b.

The electronic control unit 100 is signal-connected to said AC/DC conversion unit 46a via a link. The electronic control unit 100 is arranged to receive a signal from said AC/DC conversion unit 46a representing operational data comprising power data for determination of the generator shaft power so as to be able to determine when the desired power output exceeds what can nominally be delivered by the internal combustion engine unit. The electronic control unit 100 is arranged to send a signal to said AC/DC conversion unit 46a representing voltage data for constant voltage reference during control in accordance with the first control principle I1, and motor speed control data for motor speed control with voltage limitations during control in accordance with the second control principle I2.

The electronic control unit 100 is signal-connected to said DC/AC conversion unit 46b via a link. The electronic control unit 100 is arranged to send a signal to said DC/AC conversion unit 46b representing torque data for reference torque representing torque requested from the throttle unit 50 during control in accordance with the first control principle I1, and torque data for reference torque, where, in combination, the DC/AC conversion unit controls the torque as a function of DC voltage from the intermediate DC voltage stage 46 during control in accordance with the second control principle I2. The electronic control unit 100 is arranged to send a signal to said DC/AC conversion unit 46a representing torque data for torque reference and torque reference in combination with control of torque as a function of voltage from the intermediate DC voltage stage.

The electronic control unit 100 is signal-connected to said throttle unit 50 via a link. The electronic control unit 100 is arranged to receive a signal from said throttle unit 50 representing throttle data for requested torque, wherein said throttle data comprises torque data and wherein the requested torque constitutes reference torque.

The system I is arranged to, by means of the electronic control unit 100 and, where appropriate, a control unit of the internal combustion engine 42, a control unit of the AC/DC conversion unit, and to control unit of the DC/AC conversion unit, control the driveline 40 based on desired efficiency in case the desired power output is less than the maximum power that said internal combustion engine 42 can deliver.

In cases where the system I is arranged to control, by means of the electronic control unit, said driveline 40 based on desired efficiency, there are means of the system I that are utilized for selection of a suitable operating point of the internal combustion engine unit 42, and for controlling said electric motor unit 49 such that a desired tractive force of said electric motor unit 49 is obtained. This is achieved by a first superordinate control principle I1 which will be illustrated and explained in more detail with reference to FIGS. 3a-b.

When, during operation, the desired power output is less than what the internal combustion engine unit 42 is capable of delivering, the superordinate control principle, i.e. the first control principle, determines a suitable operating point of the internal combustion engine such that it works as energy-efficient as possible. This is illustrated schematically in FIG. 4.

The first control principle serves to limit the torque of the electric motor unit 49 such that the power that is momentarily available is not exceeded, e.g. during load changes.

In one embodiment, the motor speed of the internal combustion engine unit 42 is arranged to be controlled by means of a cascade controller of the internal combustion engine unit 42, wherein a fuel/torque controller is slave generator.

The voltage on the intermediate DC voltage stage 46 is arranged to be controlled by controlling the torque of the generator unit 44.

The electric motor unit 49 is arranged to be controlled to provide the desired driving torque.

When the desired power output exceeds or coincides with the maximum power deliverable by the internal combustion engine unit 42, the throttle unit of the internal combustion engine unit will bottom. Therefore, the speed controller of the internal combustion engine unit 42 cannot further increase the throttle when the torque of the generator unit 44 exceeds the torque of the internal combustion unit 42, which causes a reduction in motor speed of the internal combustion engine unit 42. The power of the internal combustion motor unit 42 will then be further reduced, which, if no measures are taken, will cause combustion motor unit 42 to stop.

To this end, by means of a subordinate control system according to a second control principle I2 which will be described in more detail with reference to FIGS. 5a-b, the system is arranged to control, by means of the electronic control unit 100 and where appropriate also other control units, the driveline 40 based on desired power output if the desired power output exceeds or coincides with the maximum power deliverable by the internal combustion engine unit 42.

When the system is arranged to control the driveline 40 based on desired power output by means of the electronic control unit 100 and, where appropriate, also other control units, there are means of the system I that are utilized for driving the internal combustion engine unit 42 at maximum power through maximum throttle. The system I further comprises means for controlling the motor speed by controlling the torque of the generator unit 44 while at the same time controlling the power output from the electric motor unit 49. Said AC/DC conversion unit 46a is arranged to control the speed of the internal combustion engine unit 42 and the generator unit 44. The voltage on the intermediate DC voltage stage 46 is controlled by controlling the power output of the electric motor unit 49. According to one embodiment said throttle data is processed, wherein at maximum throttle, i.e. at maximum requested torque, the electronic control unit 100 is arranged to process the torque of the DC/AC conversion unit 46b proportional to the voltage of the intermediate DC voltage stage 46 so that increasing voltage causes increasing torque.

The system I is arranged to, by means of the electronic control unit 100 and possibly also other control units, switch between control based on desired efficiency and control based on desired power output, based on operational parameters of said driveline 40, comprising the torque and the motor speed of the internal combustion engine unit.

In one embodiment, said operational parameters comprise limitations starting to apply when the throttle unit of the internal combustion engine unit 42 bottoms and cannot reach the desired motor speed. The electronic control unit 100 and possibly other control units are, according to one embodiment, arranged to receive an output signal from the speed controller of the internal combustion engine unit 42, representing power data for establishing the current power output and the maximum power currently deliverable by the internal combustion engine unit 42, and torque data from the throttle unit for desired torque, and torque data and motor speed data from the AC/DC conversion unit 46b for current torque and current motor speed and, through use thereof, determine the desired output power and the maximum power deliverable by the internal combustion engine unit 42, obtained by studying the percent part of the load signal of the internal combustion engine unit 42 and possible present limitations, and by comparing these to thereby determine if control should be based on desired efficiency or desired power output.

In one embodiment, the electronic control unit is arranged to process said power data from the AC/DC control unit 120 for desired power output and compare said power data with power data representing the maximum power deliverable by the internal combustion engine unit 42, and control in accordance with the first control principle if the desired power output is less than the maximum power deliverable by said internal combustion engine unit, or and control in accordance with the second control principle if the desired power output exceeds or coincides with the maximum power deliverable by said internal combustion engine unit

This enables utilization of the available power of the internal combustion engine in a reliable and efficient manner. Since all available power is utilized, the internal combustion engine unit does not have to be over-dimensioned. Fault tolerance acceptance is hereby increased since the power that is still available can be fully utilized in case of performance-reducing fault conditions of the internal combustion engine unit. Furthermore, this enables the lowest possible energy consumption without engine shutdown by optimizing the operating point of the internal combustion engine.

The control strategy according to the present invention, with said first and second control principles and the switching therebetween in dependence on if the desired power output is less than the maximum power deliverable by the internal combustion engine unit or coincides/exceeds said maximum power, may be used together with an energy storage device in a hybrid system, for example the energy storage device described with reference to FIG. 2. The control strategy may be used to optimize the power distribution between several different loads when the total desired power consumption of the loads exceeds the maximum power of the energy source. The control strategy can be applied and improves the performance also in systems with other power-limited energy sources, especially when the maximum power of the energy source varies with time.

FIGS. 3a-b schematically illustrate a block diagram of a first control principle I1 for controlling the system I in FIG. 2 for controlling the driveline of a vehicle according to an embodiment of the present invention, and FIG. 4 illustrates schematically the power over speed of a vehicle based on the first control principle I1 in FIGS. 3a-b. The first control principle I1 constitutes a superordinate control principle.

The first control principle illustrated in FIGS. 3a-b involves control of the driveline 40 in FIG. 2 based on desired efficiency, wherein control is based on the selection of a suitable operating point for the internal combustion engine unit 42, and wherein the electric drive motor unit is controlled such that a desired tractive force of said electric motor unit is obtained. Consequently, the first control principle I1 means control of the electric motor unit for driving.

The system I is thus arranged to, by means of the electronic control unit 100, control the driveline 40 based on the first control principle I1 in case the desired power output is less than the maximum power deliverable by said internal combustion engine unit 42. The first control principle I1 is arranged to control the electric motor unit 49, i.e. the driving motor.

According to the first control principle I1, as seen in FIG. 3a, the vehicle operator gives throttle by activating a throttle unit 50 which may be an accelerator pedal. Activation of the throttle unit 50 means that the vehicle operator requests a desired torque T_{ref} of the electric motor unit 49 for propelling the vehicle. In this way, the desired torque T_{ref} is established. In this embodiment, the establishment of desired torque takes place in the electronic control unit 100.

Furthermore, the current motor speed of the electric motor unit is established from said DC/AC conversion unit 46b, i.e. the speed measured from the electric motor unit by means of DC/AC converting unit 46b.

As seen in FIG. 3a, this means that the power P_{ref} with which the vehicle operator desires to propel the vehicle is established at the electronic control unit 100 by multiplying, by means of a multiplying unit 60, said desired torque and said current motor speed. The power P_{ref} hence represents the power that should be delivered by the internal combustion engine 42 and is therefore referred to as reference power P_{ref}. In this embodiment, the establishment of the reference power P_{ref} takes place in the electronic control unit 100 which hence comprises said multiplying unit 60.

As shown in FIG. 4, the available power of the internal combustion engine unit 42 increases to a relatively constant level. At a certain speed nₒ of the internal combustion engine unit 42, there is a risk that the internal combustion engine unit 42 overspeeds, whereby the power in risk of overspeed is reduced by means of the speed controller of the internal combustion engine unit 42. The idle speed nᵢ corresponds to a certain low speed nᵢ and the overspeed corresponds to a relatively high speed nₒ. A certain speed is required in order for the internal combustion engine unit 42 to be able to deliver the desired power. When the speed of the internal combustion engine unit 42 is increased there is a certain delay before the desired effect is achieved due to pressure build-up in the supercharger system. The rings in FIG. 4 indicate curves of constant efficiency, where the efficiency is the highest at O and then decreases with encircling rings.

The power P_{ref} is converted by a conversion unit 62 to a speed n_{ref} for the internal combustion engine unit 42 in accordance with the above conditions illustrated in FIG. 4. According to this embodiment, the conversion takes place in the electronic control unit 100, which hence comprises said conversion unit 62. The electronic control unit 100 is thus arranged to send a signal to the internal combustion engine unit 42 representative of said converted speed n_{ref} constituting the desired reference speed at which the internal combustion engine unit 42 should be able to deliver the desired power. Consequently, the desired power output is established, whereupon a reading of the speed required to achieve maximum efficiency given said power output.

The control unit of the internal combustion engine unit 42 is arranged to control the supply of fuel to the internal combustion engine unit 42. This applies to the first control principle I1 but also to a second control principle I2 described with reference to FIG. 5a-b.

The system further includes a limitation unit 64 for comparing the desired speed n_{ref} of the internal combustion engine with the current speed n_{eng} of the internal combustion engine unit 42, obtained from the control unit of the internal combustion engine unit 42. If the internal combustion engine unit 42 has not reached the desired speed the torque is limited. The limited torque T_{reflim} is determined by multiplying the desired torque T_{ref} by a factor that is proportional to the difference between n_{ref} and n_{eng}. If the internal combustion engine unit 42 has reached the desired speed, then T_{reflim}=T_{ref}, i.e. the requested torque is obtained.

Controlling the driveline in accordance with the first control principle thus enables adaption according to curve C in FIG. 4 for optimal efficiency and thus the lowest fuel consumption, which is obtained in the operational point O on curve C, where the curve C shows optimal speed in terms of fuel consumption for a certain desired power.

As shown in FIG. 3b, the AC/DC conversion unit 46a is arranged to provide the torque T_{ref} required for controlling the voltage of the AC/DC conversion unit 46a to the generator unit 44 for controlling the voltage U_{dc} over the intermediate DC voltage stage 46, where U_{dcref} constitutes the reference voltage towards which the AC/DC conversion unit 46a regulates. Furthermore, the DC/AC conversion unit 46b provides the torque T_{ref} to the electric motor unit 49 based on the torque reference T_{ref} constituting the requested torque from the throttle unit 50.

FIGS. 5a-b schematically illustrates a block diagram of a second control principle I2 for controlling the system in FIG. 2 according to an embodiment of the present invention.

The second control principle I2 involves controlling, by means of the electronic control unit 100 and possibly also other control units, the driveline 40 based on desired power output in case the desired power output exceeds or coincides with the maximum power deliverable by the internal combustion engine unit 42.

FIGS. 5a-b illustrate control of the driveline in FIG. 2 in accordance with the second control principle, wherein control is based on desired power output where the control is made by driving the internal combustion engine unit 42 with maximum power through full throttle and by controlling the speed of the internal combustion engine unit and the generator unit by controlling the torque of the generator unit through cascade control while at the same time controlling the power output of the electric motor unit by torque reference. The second control principle I2 constitutes the subordinate control principle. The driveline 40 is controlled in accordance with the second control principle I2 in case the desired power output exceeds or coincides with the maximum effect deliverable by the internal combustion engine unit 42.

According to the second control principle the vehicle operator gives throttle by activating the throttle unit 50 which may be constituted by an accelerator pedal. Hereby it has been established that the desired power output is greater or equal to the maximum power of the internal combustion engine unit 42, whereby the second control principle I2 is used.

The reference from throttle generated through activation of the throttle unit 50 is sent as a signal to the internal combustion engine unit 42, representing throttle data for percentage of throttle, corresponding to a requested torque from the vehicle operator.

Said throttle data is arranged to be processed in the electronic control unit.

Said throttle data is converted to a reference torque T_{ref} in a torque conversion unit 70 of the electronic control unit 100, where the reference torque T_{ref} corresponds to the requested torque on the output shaft of the electric motor unit 49. The torque reference is sent as a signal to the internal combustion engine unit 42.

Consequently, in this second control principle I2, the internal combustion engine unit 42 is torque-controlled with said reference torque T_{ref}. In this respect, the internal combustion engine unit 42 is controlled in accordance with the second control principle I2.

Hereby the maximum deliverable power is requested regardless of limitations or other circumstances.

Said throttle data is converted to a reference speed n_{ref} in a speed conversion unit 72 of the electronic control unit 100, where the reference speed n_{ref} corresponds to the speed at which the internal combustion engine unit 42 can generate maximum power. The speed reference n_{ref} is sent as a signal to the AC/DC conversion unit 46a. The AC/DC conversion unit 46a is thus speed-controlled and strives to cause the generator unit 44 to control the motor speed to a speed at which the internal combustion engine unit 42 can deliver maximum power, having regard to possible gearing. The electric motor unit 49 is configured to consume what is being generated. The internal combustion engine unit 42 is arranged to control the speed in cascade with the torque in accordance with control principle I.

The AC/DC conversion unit is arranged to control the torque of the shaft of the generator unit 44 whereby, according to one embodiment, control is performed such that the torque is low or substantially zero at low speeds and, when the speed is increased to the desired speed whereby torque is increased, according to one embodiment linearly, wherein the power of the internal combustion engine unit further increases the speed of the shaft of the generator unit 44, whereby additional braking torque is applied.

The change in speed of the internal combustion engine unit 42/the generator unit 44 is dependent of applied torque and the inertia of the rotating system, i.e. the internal combustion engine unit 42, possible gearing and the generator unit 44.

By controlling the speed of said AC/DC converter unit 46a there is provided a certain electric power whereby the voltage on the intermediate DC voltage stage is increased if the power that is input to the intermediate DC voltage state 46 exceeds the output power. If the voltage U_{DC} increases, a driving torque is applied to the electric motor unit 49, whereby the power becomes its speed multiplied by the torque T_{ref} and, consequently, more power is consumed with increasing voltage U_{dc}.

Said throttle data is processed in a drive assessment unit 74 of the electronic control unit 100 where it is assessed whether the generated power can be delivered, i.e. an assessment is made as to whether throttle has been requested by the vehicle operator. This is made to avoid propulsion by means of the electric motor unit 49 in case the voltage of the intermediate DC voltage stage increases without any throttle having been requested by the vehicle operator, for example due to failure of the AC/DC conversion unit, increase of the voltage in the energy storage device 48; 48a, or similar. This is because the DC/AC conversion unit 46b is arranged to provide torque as a function of voltage to the electric motor unit 49.

Consequently, information relating to activation of the throttle unit 50 through throttle adjustment is arranged to be sent, to said DC/AC conversion unit 46b to avoid propulsion in case the vehicle operator does not give throttle, i.e. in case the throttle unit 50 is not activated through throttle adjustment by the vehicle operator, wherein propulsion due to voltage increase in the intermediate DC voltage stage is arranged to be prevented in case of no throttle adjustment.

According to the second control principle I2, the AC/DC conversion unit 46a is thus arranged to provide torque T_{ref} to the generator unit 44 to control the speed, in principle to slow down to the selected speed: Moreover, the DC/AC conversion unit 46b is arranged to provide torque to the electric motor unit 49 based on the voltage U_{DC} of the intermediate DC voltage stage 46 provided that there exists a throttle request from the vehicle operator.

FIG. 6 schematically illustrates a block diagram of a method for controlling a driveline of a vehicle according to an embodiment of the present invention.

In one embodiment, the method for controlling a driveline of a vehicle comprises the step S1 of controlling the driveline based on desired efficiency, or the step S2 of controlling the driveline based on desired power output.

In one embodiment, the method for controlling a driveline of a vehicle comprises the step S3 of selecting, based on criteria related to the performance of said internal combustion engine unit, control based on desired efficiency or desired power output.

FIG. 7 schematically illustrates a block diagram of a method for controlling a driveline of a vehicle according to an embodiment of the present invention.

In one embodiment, the method for controlling a driveline of a vehicle comprises a first step S11. In this step, a desired power output and a maximum power deliverable by the internal combustion engine are determined.

In one embodiment, the method for controlling a driveline of a vehicle comprises a second step S12. In this step, it is assessed whether the desired power output is less than the maximum power deliverable by the internal combustion engine.

If the desired power output is less than the maximum power deliverable by the internal combustion engine, the method for controlling a driveline of a vehicle comprises, according to one embodiment, a third step S13a. In this step the driveline is controlled based on desired efficiency.

If the desired power output exceeds or coincides with the maximum power deliverable by the internal combustion engine, the method for controlling a driveline of a vehicle comprises, according to one embodiment, a fourth step S13b. In this step the driveline is controlled based on desired power output.

Referring to FIG. 8, a diagram illustrating an embodiment of a device 500 is shown. The control unit 100 described with reference to FIG. 2 may in one embodiment comprise the device 500. The device 500 may include a non-volatile memory 520, a data processing unit 510 and a read/write memory 550. The non-volatile memory 520 has a first memory portion 530 wherein a computer program, such as an operating system, is stored for controlling the function of the device 500. Furthermore, the device 500 comprises a bus controller, a serial communications port, I/O member, an A/D converter, a date and time input and transmission unit, an event counter and an interruption controller (not shown). The non-volatile memory 520 also has a second memory portion 540.

There is provided a computer program P comprising control of a driveline of a vehicle according to the inventive method.

The program P comprises routines for controlling the driveline based on desired efficiency, or for controlling the driveline based on desired power output. The program P comprises routines for selecting between control based on desired efficiency or control based on desired power output based on criteria related to the performance of said internal combustion engine unit.

The program P comprises, in one embodiment, routines for determining the desired power output and the maximum power deliverable by the internal combustion engine. The program P comprises routines for assessing whether the desired power output is less than the maximum power deliverable by the internal combustion engine. The program P comprises routines for controlling the driveline based on the desired efficiency if the desired power output is less than the maximum power deliverable by the internal combustion engine. The program P comprises routines for controlling the driveline based on the desired power output if the desired power output exceeds or coincides with the maximum power deliverable by the internal combustion engine.

The program P may be stored in an executable manner or in a compressed manner in a memory 560 and/or in a read/write memory 550.

When it is described that the data processing unit 510 performs a certain function it should be understood that data processing unit 510 executes a certain portion of the program which is stored in memory 560, or a certain portion of the program stored in the read/write memory 550.

The data processing device 510 may communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is arranged to communicate with the data processing unit 510 via a data bus 514. For example the links connected to the control unit 100 may be connected to the data port 599.

When data is received on the data port 599 it is temporarily stored in the second memory portion 540. When the received input data has been temporarily stored, the data processing unit 510 is prepared to perform execution of code in a manner described above.

The signals received at the data port 599 may be used by the device 500 to control the driveline based on desired efficiency, or to control the driveline based on desired power output. The signals received at the data port 599 may be used by the device 500 to, based on criteria related to the performance of said internal combustion engine unit, select control based on desired efficiency or desired power output.

The signals received at the data port 599 may be used by the device 500 to determine the desired power output and the maximum power deliverable by the internal combustion engine. The signals received at the data port 599 may be used by the device 500 to assess whether the desired power output is less than the maximum power deliverable by the internal combustion engine. The signals received at the data port 599 may be used by the device 500 to control the driveline based on the desired efficiency if the desired power output is less than the maximum power deliverable by the internal combustion engine. The signals received on the data port 599 may be used by the device 500 to control the driveline based on the desired power output if the desired power output exceeds or coincides with the maximum power deliverable by the internal combustion engine.

Parts of the methods described herein can be performed by the device 500 by means of data processing device 510 running the program stored in the memory 560 or the read/write memory 550. When the device 500 runs the program, the methods described herein are executed.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. Method A method for controlling a driveline of a vehicle, the driveline comprising an internal combustion engine unit for driving a generator unit for generating electrical energy, an electric motor unit arranged to be supplied with said electrical energy from said generator unit, an AC/DC conversion unit configured to convert AC voltage from the generator unit to DC voltage, a DC/AC conversion unit configured to convert said DC voltage to controllable AC voltage, said DC voltage being provided in an intermediate DC voltage stage, and a controller for controlling the driveline of the vehicle, the method comprising the steps of:
by use of the controller, i) controlling the driveline based on desired efficiency, or ii) controlling the driveline based on desired power output; and
iii) based on criteria related to the performance of said internal combustion engine unit, selecting control based on the desired efficiency or desired power output.

2. The method of claim 1, wherein said performance includes the maximum power deliverable by the internal combustion engine unit.

3. The method of claim 2, further comprising the step of controlling said driveline based on desired efficiency in case the desired power output is less than the maximum power deliverable by said internal combustion engine unit.

4. The method of claim 3, wherein the step of controlling said driveline based on desired efficiency comprises selection of a suitable operating point of the internal combustion engine unit and wherein said electric motor unit is controlled such that a desired tractive force of said electric motor unit is achieved.

5. The method of claim 2, further comprising the step of controlling said driveline based on desired power output in case the desired power output exceeds or coincides with the maximum power deliverable by said internal combustion engine unit.

6. The method of claim 4, wherein the step of controlling said driveline based on desired power output comprises driving the internal combustion engine unit with maximum power through maximum throttle, and controlling the motor speed by controlling the torque of the generator unit while controlling the power output of the electric motor unit.

7. The method of claim 1, further comprising the step of switching between the control based on desired efficiency and the control based on desired power output, based on operating parameters of said driveline comprising torque and motor speed of the internal combustion engine unit.

8. A system for controlling a driveline of a vehicle, comprising:
a driveline comprising an internal combustion engine unit for driving a generator unit for generating electrical energy, an electric motor unit arranged to be supplied with said electrical energy from said generator unit, an AC/DC conversion unit configured to convert AC voltage from the generator unit into DC voltage, and a DC/AC conversion unit configured to convert said DC power to controllable AC power, wherein said DC voltage is provided in an intermediate DC voltage stage, together with means for controlling the driveline of the vehicle, wherein said means for controlling the driveline comprises means for controlling the driveline based on desired efficiency; and
a controller for controlling the driveline based on desired power output, and for selecting control based on desired efficiency or desired power output, based on criteria relating to the performance of said internal combustion engine unit.

9. The system of claim 8, wherein said performance comprises the maximum power deliverable by said internal combustion engine unit.

10. The system of claim 9, wherein the controller controls said driveline based on desired efficiency in case the desired power output is less than the maximum power deliverable by said internal combustion engine unit.

11. The system of claim 10, wherein said controller for controlling said driveline based on desired efficiency is configured to select a suitable operating point of the internal combustion engine unit, and to control said electric drive motor unit such that a desired tractive force of said electric motor unit is achieved.

12. The system of claim 9, wherein the controller controls said driveline based on desired power output in case the desired power output exceeds or coincides with the maximum power deliverable by said internal combustion engine unit.

13. The system of claim 11, wherein the controller is configured to drive the internal combustion engine unit with maximum power through maximum throttle, and the motor speed by controlling the torque of the generator unit while controlling the power output of the electric motor unit.

14. The system of claim 8, wherein the controller switches between control based on desired efficiency and control based on desired power output, based on operational parameters of said driveline, comprising the torque of the internal combustion engine unit and the motor speed of the internal combustion engine unit.

15. A motor vehicle comprising the system of claim 8.

16. A computer program, stored in a non-transitory storing medium, controlling a driveline of a vehicle, wherein said computer program comprises program code which, when run on an electronic control unit or another computer connected to the electronic control unit, causes the electronic control unit to carry out the steps of claim 1.

17. A computer program product comprising a digital storage medium storing the computer program of claim 16.
